(19) United States
(12) Patent Application Publication
(10) Pub. No.: US 2024/0100988 A1
(43) Pub. Date: Mar. 28, 2024

(54) MANAGEMENT SYSTEM

(71) Applicant: SUBARU CORPORATION, Tokyo (JP)

(72) Inventor: Kazuki MAKINO, Tokyo (JP)

(21) Appl. No.: 18/462,562

(22) Filed: Sep. 7, 2023

(30) Foreign Application Priority Data
Sep. 22, 2022 (JP) 2022-151951

(51) Int. Cl. B60L 55/00; B60L 53/12

(52) U.S. Cl. CPC B60L 55/00; B60L 53/12; B60L 2240/60; B60L 2250/00

(57) ABSTRACT

A management system includes a controller that selects a power transmission vehicle from an electrified vehicle group. A storage amount of an electricity storage device loaded in each electrified vehicle increases or decreases between maximum and minimum storage amounts. When the maximum storage amount and a current storage amount currently stored in the electricity storage device are a first storage amount and a second storage amount, a reference storage amount set between the maximum and minimum storage amounts is a third storage amount, a surplus storage amount obtained by subtracting the third storage amount from the second storage amount is a fourth storage amount, and a ratio of the fourth storage amount to the first storage amount is a surplus storage amount ratio, the controller determines a rank of each electrified vehicle in descending order of the surplus storage amount ratio and selects the power transmission vehicle based on the rank.

### CROSS-REFERENCE TO RELATED APPLICATIONS

The present application claims priority from Japanese Patent Application No. 2022-151951 filed on Sep. 22, 2022, the entire contents of which are hereby incorporated by reference.

### BACKGROUND

The disclosure relates to a management system configured to select an electrified vehicle which is to be allowed to transmit electricity in a contactless manner.

These days, even in small-scale customers, such as general households, distributed energy resources, such as photovoltaic systems, fuel cells, and electric automobiles, are installed (see Japanese Unexamined Patent Application Publication (JP-A) No. 2018-186630). Integrating and centrally controlling various distributed energy resources with the Internet of things (IoT) and using them as one virtual power plant (VPP) has been proposed (see JP-A Nos. 2021-16288 and 2021-191196). That is, transmitting electricity from an electrified vehicle, such as an electric automobile, which is a distributed energy resource, to another customer has been proposed.

### SUMMARY

An aspect of the disclosure provides a management system to be used for a power receiving facility. The power receiving facility is configured to receive electricity in a contactless manner from an electrified vehicle driving in a power transmission zone. The management system is configured to select a power transmission vehicle from an electrified vehicle group of electrified vehicles driving in a determination zone. The determination zone includes at least a part of the power transmission zone. The power transmission vehicle is selected as an electrified vehicle which is to be allowed to transmit electricity in a contactless manner. The management system includes a controller. The controller includes a processor and a memory which are coupled to each other so as to communicate with each other. The controller is configured to select the power transmission vehicle from the electrified vehicle group. A storage amount of an electricity storage device loaded in each electrified vehicle forming the electrified vehicle group is to increase or decrease between a maximum storage amount of the electricity storage device and a minimum storage amount of the electrified vehicle group. The controller is configured to, when the maximum storage amount is set to a first storage amount; a current storage amount currently stored in the electricity storage device is set to a second storage amount; a reference storage amount which is set between the maximum storage amount and the minimum storage amount is set to a third storage amount; a surplus storage amount obtained by subtracting the third storage amount from the second storage amount is set to a fourth storage amount; and a ratio of the fourth storage amount to the first storage amount is set to a surplus storage amount ratio; determine a rank of each electrified vehicle forming the electrified vehicle group in descending order of the surplus storage amount ratio, and select the power transmission vehicle from the electrified vehicle group based on the rank of each electrified vehicle regarding the surplus storage amount ratio.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 illustrates an example of a virtual power plant (VPP);

FIG. 2 illustrates an example of a power receiving facility that receives electricity from an electrified vehicle;

FIG. 3 illustrates examples of a power receiving coil set, a power supply panel, and an electrified vehicle;

FIG. 4 illustrates an example of the basic structure of a central server;

FIG. 5 illustrates an example of the basic structure of each control unit;

FIGS. 6 and 7 illustrate examples of a power supply lane and a determination area;

FIGS. 8 and 9 are a flowchart illustrating an example of an execution procedure of power transmission vehicle control executed by a control system;

FIG. 10 illustrates an example of various storage amounts set for a battery;

FIG. 11 is a flowchart illustrating an execution procedure of maximum-number-of-vehicles setting control executed by the central server;

FIG. 12 is a flowchart illustrating an execution procedure of power transmission vehicle selecting control executed by the central server;

FIG. 13 illustrates an example of an electrified vehicle group in the determination area;

FIG. 14 illustrates the electrified vehicle group in the determination area and ranking for the electrified vehicle group;

FIG. 15 illustrates an example of a hybrid vehicle; and

FIG. 16 illustrates examples of various storage amounts set for a battery.

### DETAILED DESCRIPTION

Electricity may be transmitted from an electrified vehicle of a customer to another customer in the following manner, for example. A power receiving facility may be installed on a vehicle-dedicated road, such as a highway, and an electrified vehicle driving on the vehicle-dedicated road may transmit electricity to the power receiving facility in a contactless manner. However, electricity that the power receiving facility can receive in a contactless manner is limited, and it is difficult to allow all electrified vehicles wanting contactless power transmission to transmit electricity. It is thus desirable to suitably select an electrified vehicle which is to be allowed to transmit electricity from among multiple electrified vehicles wanting contactless power transmission.

It is desirable to suitably select an electrified vehicle which is to be allowed to perform contactless power transmission.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### [Virtual Power Plant]

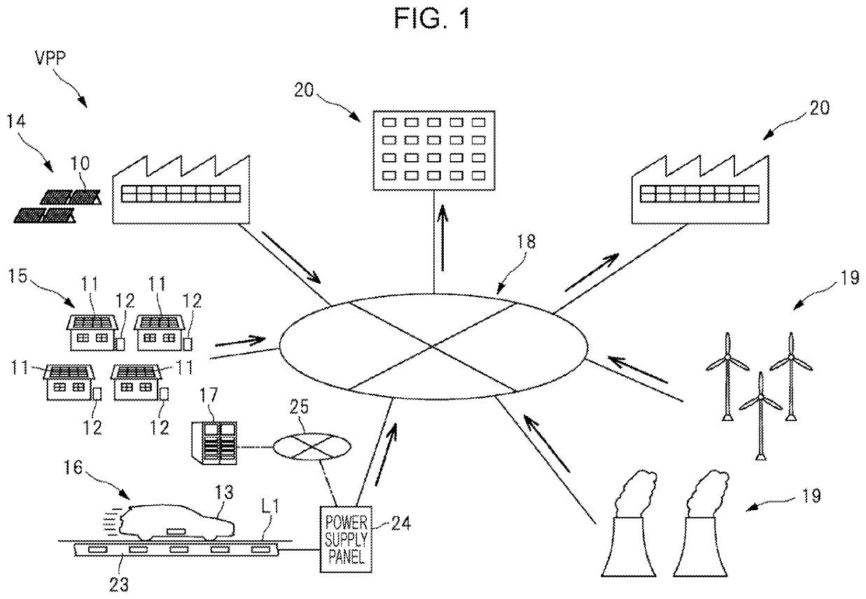

FIG. 1 illustrates an example of a virtual power plant (VPP). As illustrated in FIG. 1, even in small-scale customers, such as general households and factories, distributed energy resources 14, 15, and 16, such as photovoltaic systems 10 and 11, fuel cells 12, and electrified vehicles 13, are installed. The distributed energy resources 14, 15, and 16 are integrated and centrally controlled with the use of the Internet of things (IoT) and are used as one VPP. That is, power supply from the distributed energy resources 14, 15, and 16 to an electrical grid 18 is controlled by a central server 17 of an aggregator, which is an electricity provider. In one embodiment, the central server 17 may serve as a “controller”. To maintain the appropriate balance of supply and demand in the electrical grid 18, the central server 17 of the aggregator controls power supply from the distributed energy resources 14, 15, and 16 to the electrical grid 18, based on the situation of power generation of power generators 19 and the situation of electricity usage of customers 20. The power generators 19 and the customers 20 are linked to the electrical grid 18. An incentive is given to a customer who has provided electricity from any of the distributed energy resources 14, 15, and 16 to the electrical grid 18, in accordance with the amount of provided electricity.

### [Power Receiving Facility]

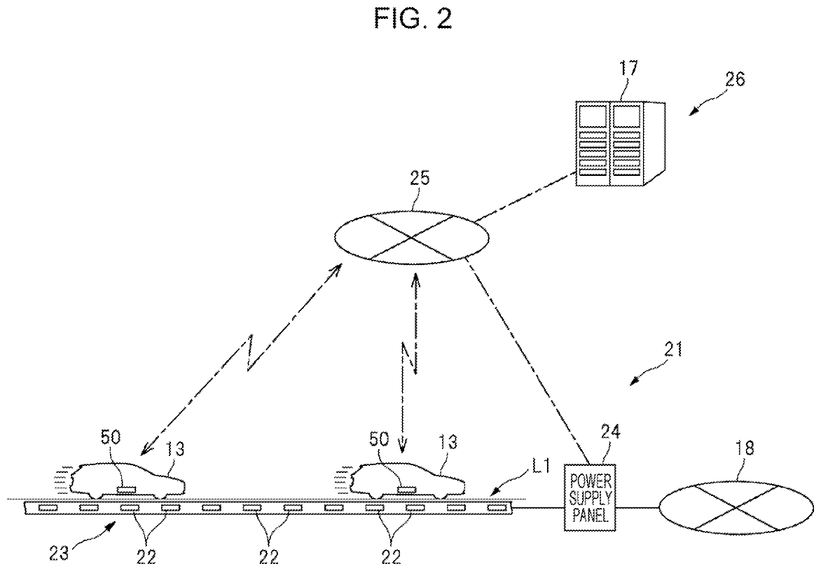

FIG. 2 illustrates an example of a power receiving facility 21 that receives electricity from electrified vehicles 13. As illustrated in FIG. 2, the power receiving facility 21 includes a power receiving coil set 23 constituted by plural power receiving coils 22 embedded in a power supply lane L1. The power receiving facility 21 also includes a power supply panel 24 that controls power supply from the power receiving coil set 23 to the electrical grid 18. The power receiving facility 21 is controlled by a management system 26 constituted by the central server 17. The central server 17 is coupled to the power supply panel 24 via a communication network 25. When an electrified vehicle 13 is driving in the power supply lane L1, electromagnetic fields of a power transmission coil 50 loaded in the electrified vehicle 13 are controlled to supply electricity from the power transmission coil 50 to the power receiving coils 22 in a contactless manner. This will be discussed later in detail. In the following description, power supply from the power transmission coil 50 to the power receiving coils 22, that is, power supply from an electrified vehicle 13 to the power receiving facility 21 will also be called contactless power transmission. The contactless power transmission from an electrified vehicle 13 to the power receiving facility 21 will also be known as wireless power transmission, contactless power feeding, and wireless power feeding.

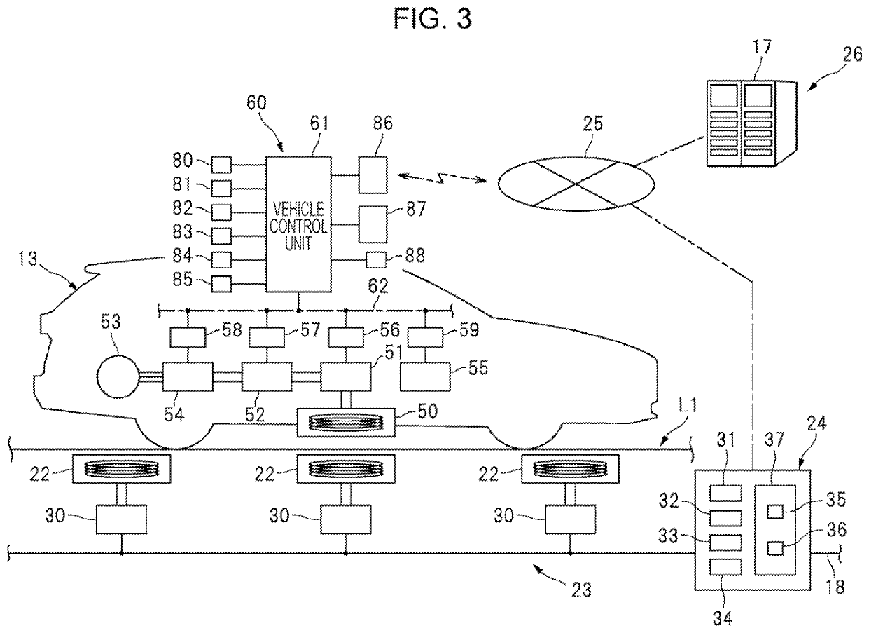

FIG. 3 illustrates examples of the power receiving coil set 23, the power supply panel 24, and the electrified vehicle 13. As illustrated in FIG. 3, the power receiving coil set 23 embedded in the power supply lane L1 includes plural power receiving coils 22 disposed at predetermined intervals and rectifying circuits 30 coupled to the respective power receiving coils 22. The power supply panel 24 includes a storage 31, such as a non-volatile memory, a communication unit 32 connected to the communication network 25, a power circuit 33, and a monitor 34. The power circuit 33 supplies electricity output from the rectifying circuits 30 to the electrical grid 18. The monitor 34 monitors power supply to the electrical grid 18. The power supply panel 24 also includes a control unit 37 to control the communication unit 32 and the power circuit 33, for example. The control unit 37 includes a processor 35 and a main memory 36, for example. A predetermined program is stored in the main memory 36 and is executed by the processor 35. The processor 35 and the main memory 36 are coupled to each other so that they can communicate with each other. A program and various items of data, for example, are stored in the storage 31, such as a non-volatile memory. Although the control unit 37 includes one processor 35 and one main memory 36 in the example in FIG. 3, it may include multiple processors 35 and/or multiple main memories 36.

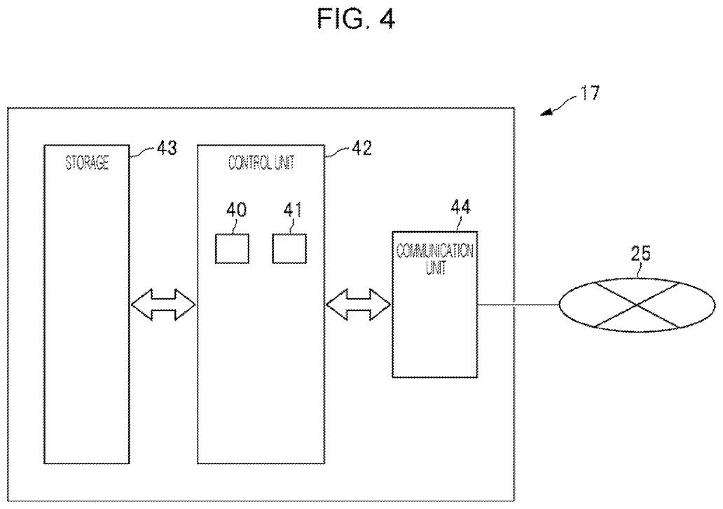

FIG. 4 illustrates an example of the basic structure of the central server 17. As illustrated in FIG. 4, the central server 17 includes a control unit 42. The control unit 42 includes a processor 40 and a main memory 41, for example. In one embodiment, the main memory 41 may serve as a “memory”. A predetermined program is stored in the main memory 41 and is executed by the processor 40. The processor 40 and the main memory 41 are coupled to each other so that they can communicate with each other. The central server 17 also includes a storage 43, such as a non-volatile memory, and a communication unit 44 connected to the communication network 25. A program and various items of data, for example, are stored in the storage 43. Although the control unit 42 includes one processor 40 and one main memory 41 in the example in FIG. 4, it may include multiple processors 40 and/or multiple main memories 41.

### [Electrified Vehicle]

As illustrated in FIG. 3, the electrified vehicle 13, such as an electric automobile, includes a power transmission coil 50, a power transmission circuit 51, and a battery 52. The power transmission coil 50 is fixed to the bottom of the vehicle body. The power transmission circuit 51 is coupled to the power transmission coil 50. The battery 52 is coupled to the power transmission circuit 51. In one embodiment, the battery 52 may serve as an “electricity storage device”. The electrified vehicle 13 also includes a driving motor 53, an inverter 54, and a steering motor 55. The driving motor 53 is coupled to the wheels. The inverter 54 controls the current supply state of the driving motor 53. The steering motor 55 drives a steering rack bar, for example, of a steering mechanism. Electronic control units for controlling devices, such as the power transmission circuit 51, loaded in the electrified vehicle 13, are coupled to the corresponding devices. That is, a power transmission control unit 56 is coupled to the power transmission circuit 51, a battery control unit 57 is coupled to the battery 52, a motor control unit 58 is coupled to the inverter 54, and a steering control unit 59 is coupled to the steering motor 55.

When contactless power transmission from the electrified vehicle 13 to the power receiving facility 21 is performed, high-frequency power is supplied from the power transmission circuit 51 to the power transmission coil 50 every time the electrified vehicle 13 passes over a power receiving coil 22 embedded in the power supply lane L1. When high-frequency power is supplied to the power transmission coil 50, the electromagnetic fields of the power transmission coil 50 and the vicinities thereof are changed, and this electromagnetic-field change is transmitted to the power receiving coil 22 by the electromagnetic-field resonance. This makes it possible to supply electricity from the power transmission coil 50 of the electrified vehicle 13 to the power receiving coils 22 of the power supply lane L1, thereby implementing contactless power transmission from the electrified vehicle 13 to the power receiving facility 21.

A control system 60 constituted by multiple electronic control units is provided in the electrified vehicle 13 to control devices, such as the power transmission circuit 51 and the driving motor 53. Examples of the electronic control units forming the control system 60 are the above-described power transmission control unit 56, battery control unit 57, motor control unit 58, and steering control unit 59. Another example of the electronic control units forming the control system 60 is a vehicle control unit 61 that outputs control signals to the power transmission control unit 56, battery control unit 57, motor control unit 58, and steering control unit 59. The power transmission control unit 56, battery control unit 57, motor control unit 58, steering control unit 59, and vehicle control unit 61 (hereinafter may also be simply called the control units 56 through 59 and 61) are coupled to each other via an in-vehicle network 62, such as a controller area network (CAN), so that they can communicate with each other.

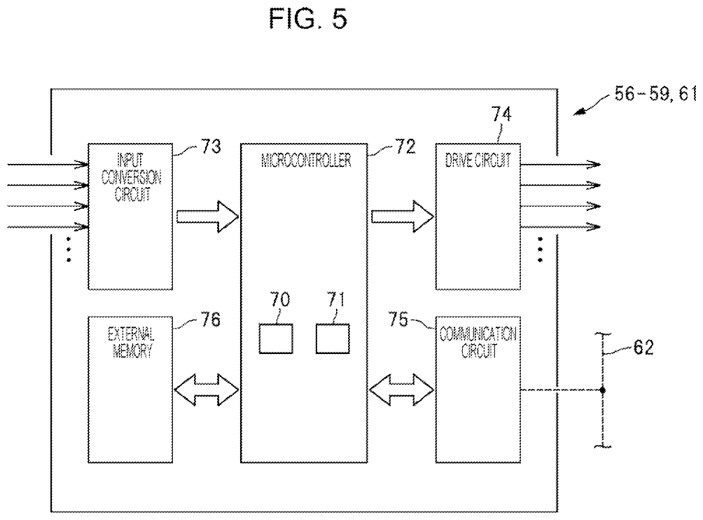

FIG. 5 illustrates an example of the basic structure of each of the control units 56 through 59 and 61. As illustrated in FIG. 5, the control units 56 through 59 and 61 each include a microcontroller 72 having a processor 70 and a main memory 71, for example, integrated therein. A predetermined program is stored in the main memory 71 and is executed by the processor 70. The processor 70 and the main memory 71 are coupled to each other so that they can communicate with each other. Although the microcontroller 72 includes one processor 70 and one main memory 71 in the example in FIG. 5, it may include multiple processors 70 and/or multiple main memories 71.

The control units 56 through 59 and 61 each include an input conversion circuit 73, a drive circuit 74, a communication circuit 75, and an external memory 76, for example. The input conversion circuit 73 converts signals input from various sensors into signals that can be input into the microcontroller 72. The drive circuit 74 generates drive signals to be input into various devices, such as the power transmission circuit 51, based on signals output from the microcontroller 72. The communication circuit 75 converts a signal output from the microcontroller 72 into a communication signal to be input into another control unit. The communication circuit 75 also converts a communication signal received from another control unit into a signal that can be input into the microcontroller 72. A program and various items of data, for example, are stored in the external memory 76, such as a non-volatile memory.

The vehicle control unit 61 sets activation targets, such as the power transmission circuit 51 and the driving motor 53, based on input information from the control units 56 through 59 and various sensors. The sensors will be discussed later. The vehicle control unit 61 then generates control signals in accordance with the activation targets, such as the power transmission circuit 51 and the driving motor 53, and outputs the generated control signals to the corresponding control units. Examples of the sensors coupled to the vehicle control unit 61 is a vehicle velocity sensor 80, an accelerator sensor 81, and a brake sensor 82. The vehicle velocity sensor 80 detects the velocity, that is, the running velocity, of the electrified vehicle 13. The accelerator sensor 81 detects an amount by which an accelerator pedal is operated. The brake sensor 82 detects an amount by which a brake pedal is operated. Other examples of the sensors coupled to the vehicle control unit 61 are a radar unit 83 and a camera unit 84. The radar unit 83 detects obstacles, for example, around the electrified vehicle 13. The camera unit 84 images an area around the electrified vehicle 13. A global positioning system (GPS) receiver 85, a communication unit 86, a setting device 87, and a start switch 88 are also coupled to the vehicle control unit 61. The GPS receiver 85 receives signals from GPS satellites. The communication unit 86 is connected to the communication network 25. The setting device 87 is operated by a driver who drives the electrified vehicle 13 so as to set various conditions for contactless power transmission, which will be discussed later. The start switch 88 is operated by the driver to start the control system 60.

### [Power Supply Lane and Determination Area]

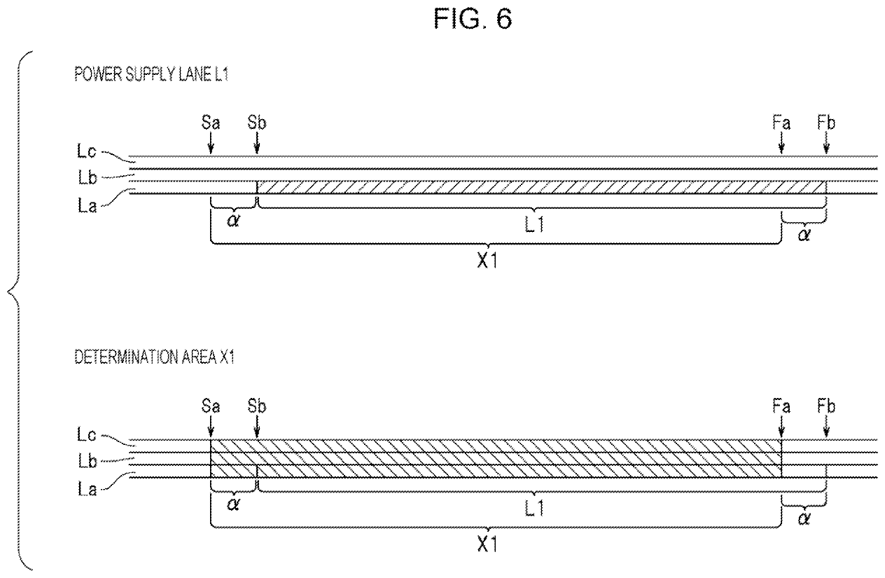

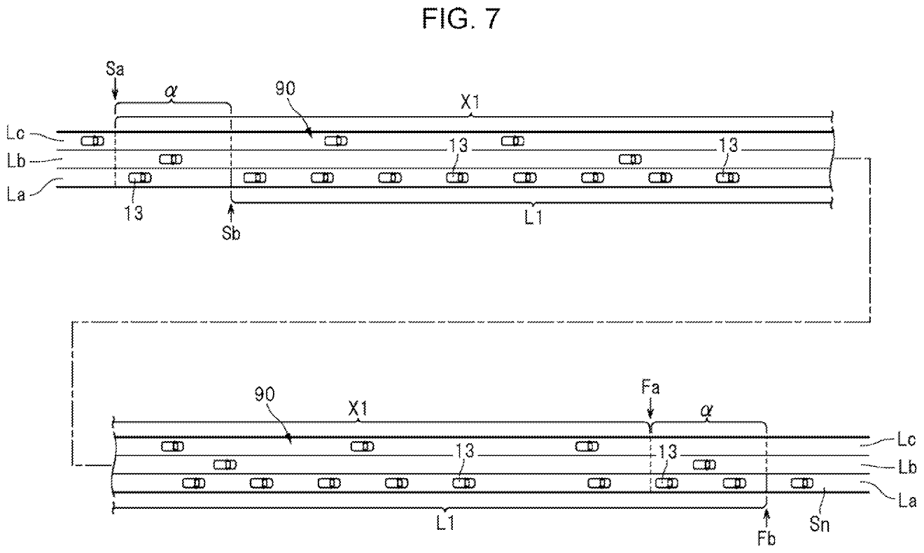

FIGS. 6 and 7 illustrate examples of the power supply lane L1 and a determination area X1. As illustrated in FIG. 6, there are three drive lanes La, Lb, and Lc in a vehicle-dedicated road, such as a highway. As indicated by the hatched portion in the upper part of FIG. 6, in the drive lane La, a power supply lane L1 having a power receiving coil set 23 embedded therein is installed over a predetermined distance. In one embodiment, the power supply lane L1 may serve as a “power transmission zone”. As indicated by the hatched portion in the lower part of FIG. 6, the determination area X1 is set in the power supply lane L1 to determine electrified vehicles 13 which are to be allowed to perform contactless power transmission. In one embodiment, the determination area X1 may serve as a “determination zone”. As illustrated in FIGS. 6 and 7, a start point Sa of the determination area X1 is located prior to a start point Sb of the power supply lane L1 by a predetermined distance a and an end point Fa of the determination area X1 is also located prior to an end point Fb of the power supply lane L1 by the predetermined distance cx.

In the example of FIGS. 6 and 7, the start point Sa of the determination area X1 is located prior to the start point Sb of the power supply lane L1. However, this is only an example. The start point Sa of the determination area X1 may be the same position as the start point Sb of the power supply lane L1. In the example of FIGS. 6 and 7, the end point Fa of the determination area X1 is located prior to the end point Fb of the power supply lane L1. However, this is only an example. The end point Fa of the determination area X1 may be the same position as the end point Fb of the power supply lane L1. That is, the determination area X1 may be set so as to contain at least part of the power supply lane L1 therein.

### [Power Transmission Vehicle Control]

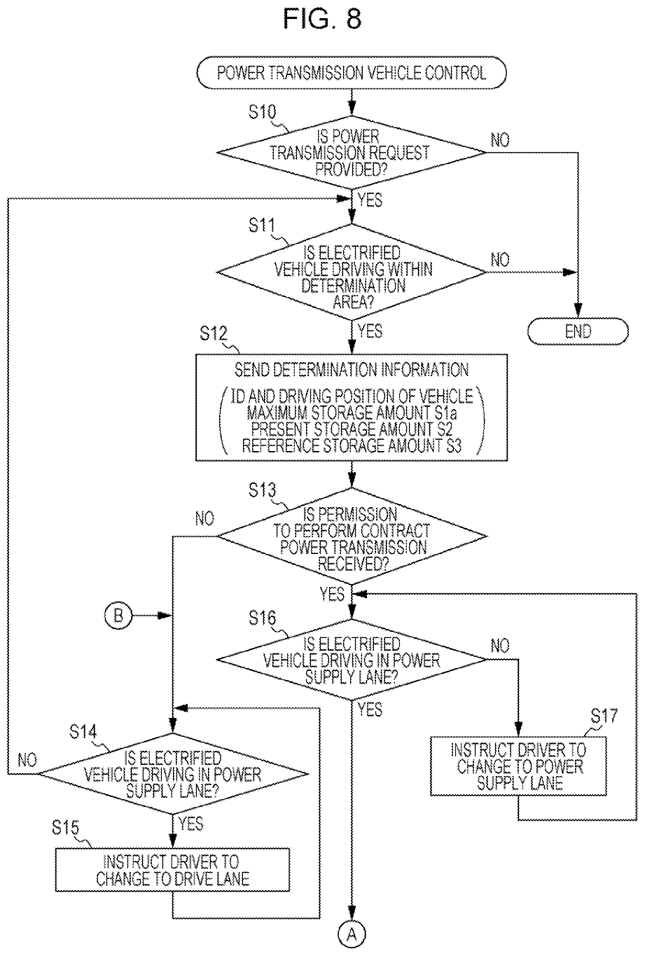

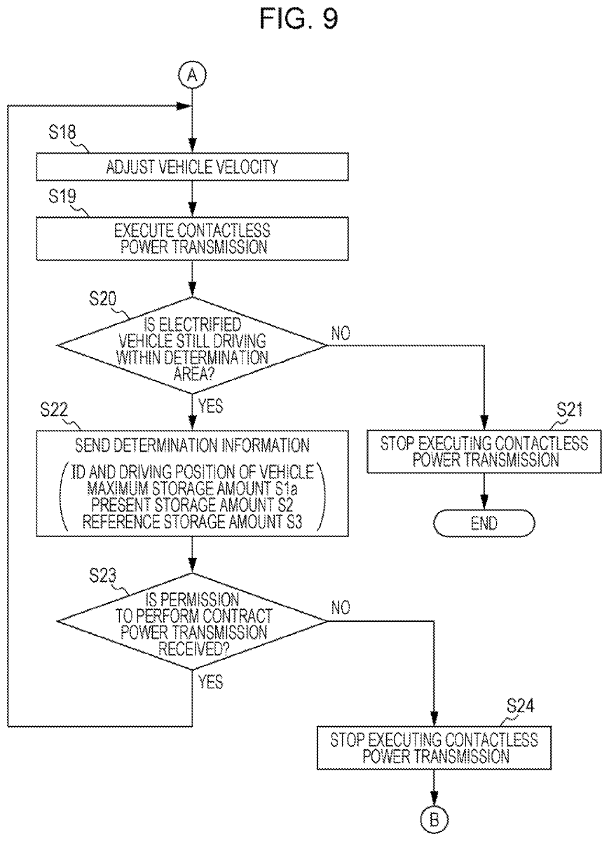

Power transmission vehicle control executed by the control system 60 will be described below. FIGS. 8 and 9 are a flowchart illustrating an example of an execution procedure of power transmission vehicle control executed by the control system 60. In the flowchart of FIGS. 8 and 9, FIGS. 8 and 9 are linked at positions indicated by A and B within a circle. Each step in the flowchart represents an operation executed by the processor 70 forming the control system 60. Power transmission vehicle control illustrated in FIGS. 8 and 9 is executed at predetermined regular intervals by the control system 60 of each electrified vehicle 13 entering the determination area X1.

As illustrated in FIG. 3, the setting device 87 to be operated by the driver driving the electrified vehicle 13 to set conditions for contactless power transmission is coupled to the vehicle control unit 61. One of the various conditions for contactless power transmission is a setting regarding whether a power transmission request is provided, that is, whether the driver has selected to perform contactless power transmission. Another condition for contactless power transmission is a setting for a reference storage amount S3 of the battery 52. The reference storage amount S3 of the battery 52 is a lower limit value of the storage amount of the battery 52 to be secured after the execution of contactless power transmission. The reference storage amount S3 will be discussed later in detail. In one embodiment, the reference storage amount S3 may serve as a “third storage amount”.

In FIG. 8, in step S10, the control system 60 determines whether a request to perform contactless power transmission is provided, that is, whether the driver has selected to perform contactless power transmission. If such a request is provided, the control system 60 proceeds to step S11 to determine whether the electrified vehicle 13 is driving within the determination area X1. If it is determined that the electrified vehicle 13 is driving in the determination area X1, the control system 60 proceeds to step S12. In step S12, various items of determination information are sent from the control system 60 of the electrified vehicle 13 to the central server 17. One item of determination information to be sent to the central server 17 is a vehicle ID, which is identification information of the electrified vehicle 13, and the driving position of the electrified vehicle 13. The vehicle control unit 61 calculates the driving position of the electrified vehicle 13, based on a signal sent from a GPS satellite.

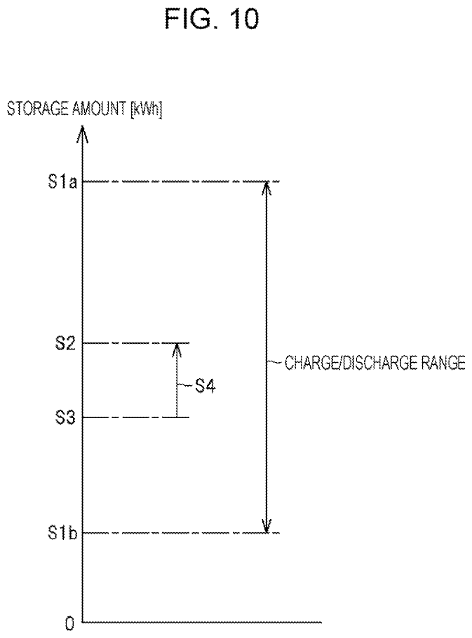

Other items of determination information are a maximum storage amount S1, a present storage amount S2, and the reference storage amount S3 of the battery 52 loaded in the electrified vehicle 13. FIG. 10 illustrates an example of various storage amounts set for the battery 52 loaded in the electrified vehicle 13. As illustrated in FIG. 10, a maximum storage amount S1a and a minimum storage amount S1b are set for the battery 52. In one embodiment, the maximum storage amount S1a may serve as a “first storage amount”. The storage amount of the battery 52 increases and decreases between the maximum storage amount S1a and the minimum storage amount S1b. That is, when the battery 52 is charged, the storage amount can increase up to the maximum storage amount S1a, while, when the battery 52 is discharged, the storage amount can decrease up to the minimum storage amount S1b.

The present storage amount S2 of the battery 52 is a storage amount currently stored in the battery 52. The present storage amount S2 can be calculated by the battery control unit 57, based on the charge/discharge current and the open circuit voltage of the battery 52, for example. In one embodiment, the present storage amount S2 may serve as a “second storage amount”. The reference storage amount S3 is set between the maximum storage amount S1a and the minimum storage amount S1b. As discussed above, the reference storage amount S3 is a lower limit value of the storage amount of the battery 52 to be secured after the execution of contactless power transmission. The reference storage amount S3 may be a storage amount which is set by the driver using the setting device 87 or may be a storage amount which is sufficiently large for the electrified vehicle 13 to drive a distance until a destination. If a storage amount sufficiently large for the electrified vehicle 13 to drive a distance until a destination is set as the reference storage amount S3, the vehicle control unit 61 calculates the reference storage amount S3 based on the distance until the destination and the latest electricity consumption. The destination, which can be used as an index to setting the reference storage amount S3, is a destination input into a navigation system by the driver, for example.

After various items of determination information are sent to the central server 17 in step S12, the control system 60 proceeds to step S13 to determine whether an enable signal indicating that the central server 17 has provided permission to perform contactless power transmission is received. If the electrified vehicle 13 has not received an enable signal, that is, if the electrified vehicle 13 has received a disable signal indicating that the central server 17 has provided no permission to perform contactless power transmission, the electrified vehicle 13 is to exit from the power supply lane L1. The control system 60 thus proceeds to step S14 to determine whether the electrified vehicle 13 is driving in the power supply lane L1. If the electrified vehicle 13 is driving in the power supply lane L1, the control system 60 proceeds to step S15 to instruct the driver driving the electrified vehicle 13 to change to the drive lane Lb. Then, the control system 60 returns to step S14. If it is found in step S14 that the electrified vehicle 13 is not driving in the power supply lane L1, the control system 60 returns to step S11 and repeats the above-described steps.

If it is determined in step S13 that an enable signal is received from the central server 17, the electrified vehicle 13 is to drive within the power supply lane L1. The control system 60 thus proceeds to step S16 whether the electrified vehicle 13 is driving in the power supply lane L1. If it is found in step S16 that the electrified vehicle 13 is not driving in the power supply lane L1, the control system 60 proceeds to step S17 to instruct the driver to change to the power supply lane L1. If it is found in step S16 that the electrified vehicle 13 is driving in the power supply lane L1, the control system 60 proceeds to step S18 in FIG. 9. When the control system 60 causes the electrified vehicle 13 to change to the power supply lane L1 or to the drive lane Lb, it may perform autonomous drive control to cause the electrified vehicle 13 to change lanes. The vehicle control unit 61 may cause the electrified vehicle 13 to change lanes by controlling the inverter 54 and the steering motor 55, for example, while monitoring the area around the electrified vehicle 13 by using the radar unit 83 and the camera unit 84.

In step S18 in FIG. 9, based on a target velocity used for contactless power transmission and sent from the central server 17, the control system 60 controls the inverter 54, for example, to adjust the velocity of the electrified vehicle 13 toward this target velocity. Then, in step S19, high-frequency power is supplied from the power transmission circuit 51 to the power transmission coil 50 of the electrified vehicle 13, thereby executing contactless power transmission from the power transmission coil 50 to the power receiving coils 22. After contactless power transmission is executed in this manner, the control system 60 proceeds to step S20. In step S20, the control system 60 determines whether the electrified vehicle 13 is still driving within the determination area X1 corresponding to the power supply lane L1. If it is found in step S20 that the electrified vehicle 13 is no longer driving within the determination area X1, that is, the electrified vehicle 13 has reached the end point Fa of the determination area X1, the control system 60 proceeds to step S21. In step S21, the control system 60 stops executing contactless power transmission from the electrified vehicle 13 to the power receiving facility 21 and exits from the routine.

If it is found in step S20 that the electrified vehicle 13 is still driving within the determination area X1, that is, the electrified vehicle 13 has not yet reached the end point Fa of the determination area X1, the control system 60 proceeds to step S22. In step S22, various items of determination information are sent from the control system 60 of the electrified vehicle 13 to the central server 17. The control system 60 then proceeds to step S23 to determine whether an enable signal indicating that the central server 17 has provided permission to perform contactless power transmission is received. If the electrified vehicle 13 has not received an enable signal from the central server 17, that is, if the electrified vehicle 13 has received a disable signal from the central server 17, the control system 60 proceeds to step S24. In step S24, the control system 60 stops executing contactless power transmission from the electrified vehicle 13 to the power receiving facility 21 and returns to step S14 in FIG. 8 to determine whether the electrified vehicle 13 is driving in the power supply lane L1. If the electrified vehicle 13 is driving in the power supply lane L1, the electrified vehicle 13 is to exist from the power supply lane L1. The control system 60 thus proceeds to step S15 to instruct the driver driving the electrified vehicle 13 to change to the drive lane Lb. If it is found in step S23 that the electrified vehicle 13 has received an enable signal from the central server 17, the control system 60 returns to step S18. In step S18, the velocity of the electrified vehicle 13 is adjusted to the target velocity. The control system 60 then proceeds to step S19 and continues executing contactless power transmission from the electrified vehicle 13 to the power receiving facility 21.

### [Maximum-Number-of-Vehicles Setting Control and Power Transmission Vehicle Selecting Control]

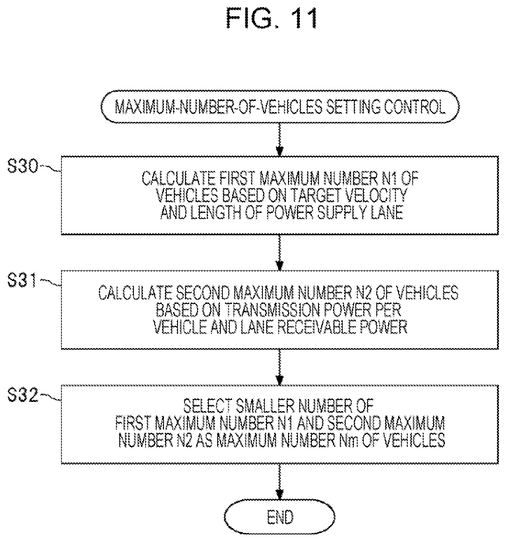

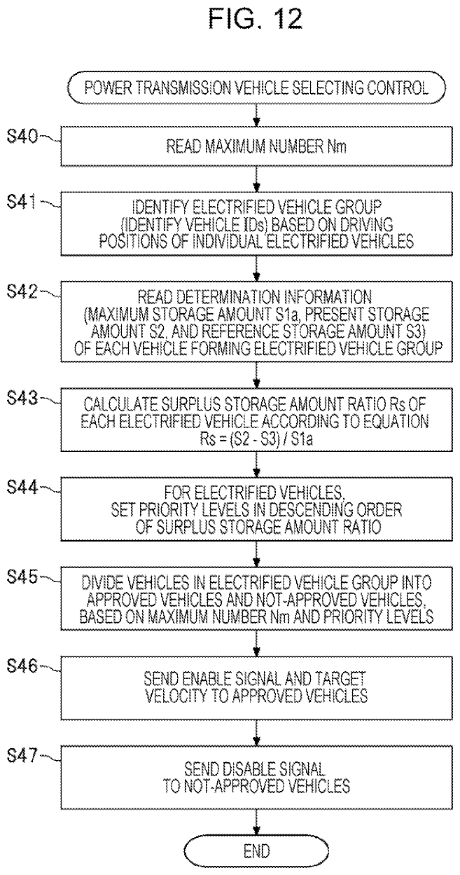

Maximum-number-of-vehicles setting control and power transmission vehicle selecting control executed by the central server 17 will now be described below. FIG. 11 is a flowchart illustrating an execution procedure of maximum-number-of-vehicles setting control executed by the central server 17. FIG. 12 is a flowchart illustrating an execution procedure of power transmission vehicle selecting control executed by the central server 17. Each step in the flowcharts in FIGS. 11 and 12 represents an operation executed by the processor 40 forming the central server 17. Maximum-number-of-vehicles setting control illustrated in FIG. 8 and power transmission vehicle selecting control illustrated in FIG. 9 are executed by the central server 17 at predetermined regular intervals.

### (Maximum-Number-of-Vehicles Setting Control)

In step S30 in FIG. 11, the central server 17 calculates a first maximum number N1 of vehicles that can transmit electricity in the power supply lane L1, based on the total distance of the power supply lane L1 and the target velocity, which is sent from the central server 17 to each electrified vehicle 13. That is, the central server 17 sets a vehicle-to-vehicle distance based on the target velocity and divides the total distance of the power supply lane L1 by the vehicle-to-vehicle distance so as to calculate the first maximum number N1 of vehicles in the power supply lane L1. For example, when a low target velocity is set, a narrow vehicle-to-vehicle distance can be set and a greater first maximum number N1 is calculated. In contrast, when a high target velocity is set, a wide vehicle-to-vehicle distance is set and a smaller first maximum number N1 is calculated. That is, the first maximum number N1 set by the central server 17 increases as the target velocity is lower, while the first maximum number N1 decreases as the target velocity is higher. The target velocity to be sent from the central server 17 to each electrified vehicle 13 is set in terms of the power transmission efficiency in contactless power transmission. Additionally, a safe vehicle-to-vehicle distance varies depending on the road condition, and the target velocity may also be set based on the weather, which is a cause for changing the road condition.

In step S31, a second maximum number N2 of vehicles that can transmit electricity in the power supply lane L1 is calculated based on transmission power per vehicle and lane receivable power, which is the highest power that can be received by the power receiving facility 21. That is, the second maximum number N2 of vehicles in the power supply lane L1 is calculated by dividing the lane receivable power by the transmission power per vehicle. For example, a greater maximum number N2 is calculated as power that can be supplied from the power receiving facility 21 to the electrical grid 18 increases and the lane receivable power in the power supply lane L1 rises. In contrast, a smaller maximum number N2 is calculated as power that can be supplied from the power receiving facility 21 to the electrical grid 18 decreases and the lane receivable power in the power supply lane L1 decreases. Then, in step S32, the first maximum number N1 and the second maximum number N2 are compared with each other and the smaller number is selected as a maximum number Nm of vehicles. The magnitude of lane receivable power is set by the central server 17, based on the supply and demand balance of the electrical grid 18.

### (Power Transmission Vehicle Selecting Control)

In step S40 in FIG. 12, the maximum number Nm set in maximum-number-of-vehicles setting control is read. In step S41, based on the driving positions sent from individual electrified vehicles 13 having entered the determination area X1, the central server 17 identifies an electrified vehicle group 90 constituted by electrified vehicles 13 having entered the determination area X1. That is, the central server 17 identifies the vehicle IDs of the individual electrified vehicles 13 driving in the determination area X1. Then, in step S42, determination information, such as the maximum storage amount S1a, present storage amount S2, and reference storage amount S3, of each of the electrified vehicles 13 forming the identified electrified vehicle group 90, is read. Then, in step S43, a surplus storage amount ratio Rs is calculated based on the maximum storage amount S1a, present storage amount S2, and reference storage amount S3 according to the following equation (1). That is, as illustrated in FIG. 10, the storage amount obtained by subtracting the reference storage amount S3 from the present storage amount S2 is set to a surplus storage amount S4, and the ratio of the surplus storage amount S4 to the maximum storage amount S1a is calculated as the surplus storage amount ratio Rs.

Rs=(S2−S3)/S1a (1)

In one embodiment, the surplus storage amount S4 may serve as a fourth storage amount.

In step S44, for the electrified vehicles 13 forming the electrified vehicle group 90, priority levels are set in descending order of the surplus storage amount ratio Rs. Then, in step S45, based on the maximum number Nm and the priority levels, the electrified vehicles 13 forming the electrified vehicle group 90 are divided into approved vehicles, which are electrified vehicles 13 to be allowed to perform contactless power transmission, and not-approved vehicles, which are electrified vehicles 13 not to be allowed to perform contactless power transmission. That is, until the maximum number Nm is reached, approved vehicles are selected from the electrified vehicle group 90 in accordance with the priority levels. In one embodiment, an approved vehicle may serve as a “power transmission vehicle”. After approved vehicles are selected from the electrified vehicle group 90 in the determination area X1, in step S46, an enable signal and the target velocity are sent from the central server 17 to the electrified vehicles 13 selected as approved vehicles. Then, in step S47, a disable signal is sent from the central server 17 to the electrified vehicles 13 selected as not-approved vehicles.

[Ranking of Electrified Vehicles under Power Transmission Vehicle Selecting Control]

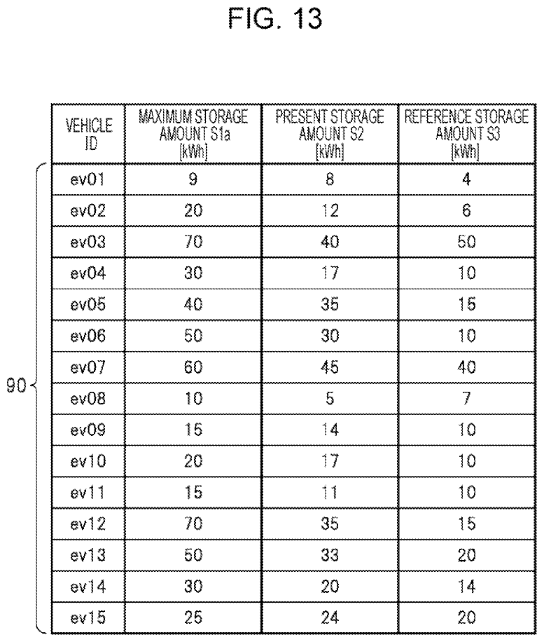

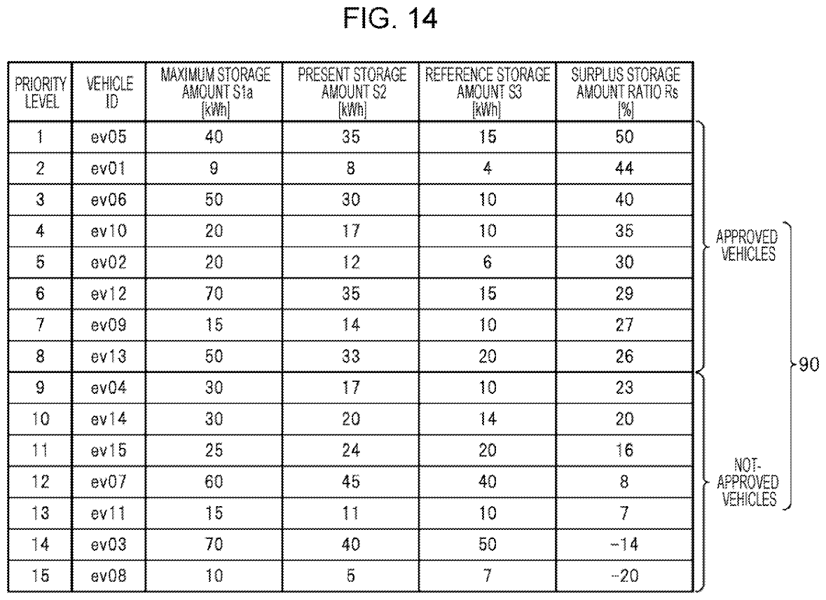

FIG. 13 illustrates an example of the electrified vehicle group 90 in the determination area X1. FIG. 14 illustrates the electrified vehicle group 90 in the determination area X1 and ranking for the electrified vehicle group 90. In the example in FIGS. 13 and 14, the maximum number Nm is set to eight and the electrified vehicles 13 are labeled as ev01 through ev15.

As illustrated in FIG. 13, the electrified vehicle group 90 constituted by the electrified vehicles ev01 through ev15 is driving in the determination area X1. In this case, the maximum storage amount S1a, present storage amount S2, and reference storage amount S3 are sent from each of the electrified vehicles ev01 through ev15 to the central server 17. Then, as illustrated in FIG. 14, based on the maximum storage amount S1a, present storage amount S2, and reference storage amount S3, the surplus storage amount ratio Rs is calculated and the electrified vehicles ev01 through ev15 are ranked in descending order of the surplus storage amount ratio Rs. Since the maximum number Nm of vehicles in the determination area X1 is eight in the examples in FIGS. 13 and 14, eight electrified vehicles ev05, ev01, ev06, ev10, ev02, ev12, ev09, and ev13 are selected as approved vehicles to be allowed to perform contactless power transmission.

As discussed above, the central server 17 calculates the surplus storage amount ratio Rs based on the maximum storage amount S1a, present storage amount S2, and reference storage amount S3, and then determines the ranks of the electrified vehicles 13 in descending order of the surplus storage amount ratio Rs. This makes it possible to suitably select electrified vehicles 13 which are to be allowed to perform contactless power transmission without giving a higher priority to an electrified vehicle 13 having a large battery capacity, that is, a large maximum storage amount S1a. Since power transmission involves incentives, many drivers may wish to perform contactless power transmission. That is, there may be a case where power transmission vehicles are selected from many electrified vehicles 13. Even in this case, power transmission vehicles can be selected in a fair manner without giving a higher priority to an electrified vehicle 13 having a large battery capacity. Additionally, the surplus storage amount ratio Rs is calculated using the reference storage amount S3 which is to be secured after contactless power transmission. It is thus possible to avoid an excessive decrease in the present storage amount S2 even after performing contactless power transmission.

[Surplus Storage Amount Ratio of Electrified Vehicle with Fuel Tank]

The electrified vehicle 13 that can perform contactless power transmission is not limited to a vehicle configured as illustrated in FIG. 3. Other examples of the electrified vehicle 13 that can perform contactless power transmission are a hybrid vehicle including an engine and an electric motor and a fuel cell vehicle including a fuel cell. In a hybrid vehicle, a fuel tank storing a fuel, such as gasoline, is loaded. In a fuel cell vehicle, a hydrogen tank (fuel tank) storing hydrogen is loaded. In this manner, a vehicle, such as a hybrid vehicle or a fuel cell vehicle including a fuel tank, has an energy source other than the battery 52. To calculate the surplus storage amount ratio Rs of such a vehicle, a fuel stored in a fuel tank can be converted into a storage amount.

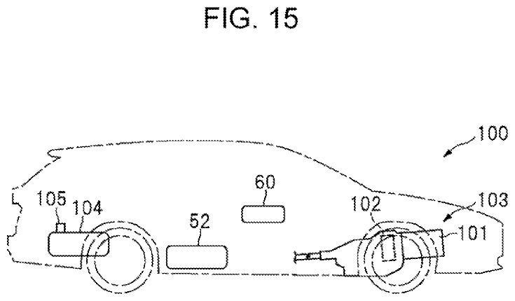

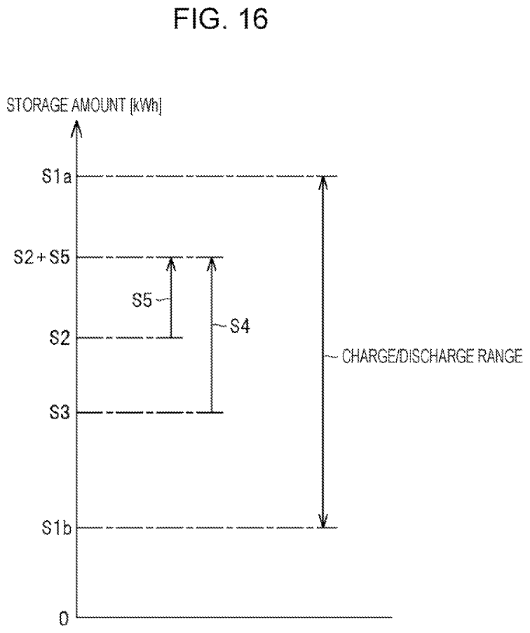

FIG. 15 illustrates an example of a hybrid vehicle 100. FIG. 16 illustrates examples of various storage amounts set for the battery 52. In one example, the hybrid vehicle 100 is an example of an electrified vehicle. In FIG. 15, components similar to those in FIG. 3 are designated by like reference numerals and an explanation thereof will be omitted. As illustrated in FIG. 15, in the hybrid vehicle 100, a power unit 103 including an engine 101 and an electric motor 102 is loaded. In the hybrid vehicle 100, the battery 52 to be coupled to the electric motor 102 is also loaded and a fuel tank 104 storing a fuel, such as gasoline, is also loaded. A level sensor 105, which measures the height of a liquid surface, is installed in the fuel tank 104. The control system 60 calculates the amount of fuel in the fuel tank 104, based on a detection signal from the level sensor 105. The control system 60 then multiplies the calculated amount of fuel in the fuel tank 104 by a predetermined coefficient so as to calculate the storage amount converted from the amount of fuel as a converted storage amount S5. In one embodiment, the converted storage amount S5 may serve as a “fifth storage amount”.

In the hybrid vehicle 100, the surplus storage amount ratio Rs is calculated based on the maximum storage amount S1a, present storage amount S2, converted storage amount S5, and reference storage amount S3 according to the following equation (2). That is, as illustrated in FIG. 16, the storage amount obtained by subtracting the reference storage amount S3 from a total amount of the present storage amount S2 and the converted storage amount S5 is set to the surplus storage amount S4, and the ratio of the surplus storage amount S4 to the maximum storage amount S1a is calculated as the surplus storage amount ratio Rs. In this manner, the surplus storage amount ratio Rs is calculated by using the converted storage amount S5 obtained by converting the amount of fuel stored in the fuel tank 104. It is thus possible to suitably select electrified vehicles 13 which are to be allowed to perform contactless power transmission even when another type of electrified vehicle, such as the hybrid vehicle 100, is included in the electrified vehicle group 90.

Rs=(S2+S5−S3)/S1a (2)

As discussed above, in the hybrid vehicle 100 including the fuel tank 104, the amount of fuel in the fuel tank 104 can be first converted into the storage amount, and then, the surplus storage amount ratio Rs can be calculated based on the converted storage amount as well as other types of storage amounts. However, this is only an example. Even in an electrified vehicle including a fuel tank 104, such as the hybrid vehicle 100, the surplus storage amount ratio Rs may be calculated based on the above-described equation (1) without converting the amount of fuel into the storage amount.

The disclosure is not limited to the above-described embodiment, and various modifications may be made without departing from the spirit and scope of the disclosure. In the above-described embodiment, the single central server 17 is used to execute the individual steps of maximum-number-of-vehicles setting control and power transmission vehicle selecting control. However, plural servers may be used to execute the steps of these control operations. In the above-described embodiment, the surplus storage amount ratio Rs is calculated in the central server 17. Instead, for example, each individual electrified vehicle 13 may calculate the surplus storage amount ratio Rs.

In the above-described embodiment, the first maximum number N1 and the second maximum number N2 are compared with each other and the smaller number is selected as the maximum number Nm. Nevertheless, the maximum number Nm may be set in a different manner. The maximum number Nm may be set only by using the first maximum number N1. The maximum number Nm may be set only by using the second maximum number N2. The power receiving facility 21 illustrated in FIG. 2 is a magnetic-field-resonance power receiving facility. However, the power receiving facility 21 is not limited to this type of facility and may be any type if it is a contactless power receiving facility. For example, an electromagnetic-induction power receiving facility or a microwave power receiving facility may be used.

According to an aspect of the disclosure, a controller determines the ranks of electrified vehicles forming an electrified vehicle group in descending order of the surplus storage amount ratio and selects electrified vehicles from the electrified vehicle group as power transmission vehicles, based on the ranks of the electrified vehicles regarding the surplus storage amount ratio. This makes it possible to suitably select an electrified vehicle which is to be allowed to perform contactless power transmission.

The control system 60 illustrated in FIG. 3 and the central server 17 illustrated in FIG. 4 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the control system 60 illustrated in FIG. 3 and the central server 17 illustrated in FIG. 4. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIGS. 3 and 4.

1. A management system to be used for a power receiving facility, the power receiving facility being configured to receive electricity in a contactless manner from an electrified vehicle driving in a power transmission zone, the management system being configured to select a power transmission vehicle from an electrified vehicle group of electrified vehicles driving in a determination zone, the determination zone including at least a part of the power transmission zone, the power transmission vehicle being selected as an electrified vehicle which is to be allowed to transmit electricity in a contactless manner, the management system comprising:
a controller comprising a processor and a memory which are coupled to each other so as to communicate with each other, the controller being configured to select the power transmission vehicle from the electrified vehicle group,
wherein a storage amount of an electricity storage device loaded in each electrified vehicle forming the electrified vehicle group is to increase or decrease between a maximum storage amount of the electricity storage device and a minimum storage amount of the electricity storage device, and
wherein, the controller is configured to, when
the maximum storage amount is set to a first storage amount,
a current storage amount currently stored in the electricity storage device is set to a second storage amount,
a reference storage amount which is set between the maximum storage amount and the minimum storage amount is set to a third storage amount,
a surplus storage amount obtained by subtracting the third storage amount from the second storage amount is set to a fourth storage amount, and
a ratio of the fourth storage amount to the first storage amount is set to a surplus storage amount ratio,
determine a rank of each electrified vehicle forming the electrified vehicle group in descending order of the surplus storage amount ratio and select the power transmission vehicle from the electrified vehicle group based on the rank of each electrified vehicle regarding the surplus storage amount ratio.

2. The management system according to claim 1, wherein the reference storage amount is a storage amount which is sufficiently large for the each electrified vehicle forming the electrified vehicle group to drive a distance until a destination.

3. The management system according to claim 1, wherein the reference storage amount is a storage amount which is set by a driver who drives the each electrified vehicle forming the electrified vehicle group.

4. The management system according to claim 1, wherein, when a fuel tank is loaded in one of the electrified vehicles forming the electrified vehicle group,
a storage amount converted from an amount of fuel in the fuel tank is set to a fifth storage amount, and
a surplus storage amount obtained by subtracting the third storage amount from a total amount of the second storage amount and the fifth storage amount is set to the fourth storage amount.
